(19) United States
(12) Patent Application Publication
(10) Pub. No.: US 2013/0139747 A1
(43) Pub. Date: Jun. 6, 2013

(54) UNIVERSAL ROCKER FOR INDICATING AN OCCUPANCY STATE IN AN OVERHEAD-CONVEYOR SYSTEM

(71) Applicant: SSI SCHAEFER PEEM GMBH, Graz (AT)

(72) Inventor: Max Winkler, Graz (AT)

(73) Assignee: SSI SCHAEFER PEEM GMBH, Graz (AT)

(21) Appl. No.: 13/683,009

(22) Filed: Nov. 21, 2012

(30) Foreign Application Priority Data
Nov. 21, 2011 (DE) 102011119410.3

(51) Int. Cl. G01D 7/00

(52) U.S. Cl. CPC G01D 7/00
USPC 116/200

(57) ABSTRACT

A rocker comprising: an inquiry sword having a long body, wherein a longitudinal extension of the long body comprises a first end and an opposite second end, wherein a continuous opening is provided in the body, the opening preferably being arranged closer to the second end than to the first free end, wherein the sword is arranged within a region which is crossed by the conveying goods when the conveying goods pass the rocker; and a bearing comprising a socket, that reaches through the opening of the sword.

### CROSS REFERENCE TO RELATED APPLICATION

This application claims priority of the German patent application DE 10 2011 119 410.3, entitled “Universelle Belegt-Wippe für Hängeförderanlage” and filed on Nov. 21, 2011, which is fully incorporated herewith by reference.

### BACKGROUND OF THE INVENTION

The present invention relates to a universally applicable occupancy rocker, or seesaw, capable of detecting, in an overhead-conveyor system, whether an accumulation line is completely filled (occupied). In this case, the accumulation line is occupied and cannot be filled additionally. An occupancy rocker in accordance with the invention is used, for example, if hanging goods are sorted and delivered to so-called discharge bars. The discharge bars are parts of the overhead-conveyor system. Starting at a specific position on this bar, an occupancy notification needs to be issued since otherwise the line would fill up, and collisions with still passing hanging goods on a main conveying line could occur. With another application, the hanging goods are transported and accumulated by means of an (overhead) conveyor capable to accumulate. With still another application, the hanging goods are supplied in cycles to a conveyor, which is not capable of accumulating, i.e. the hanging goods are moved downstream. In this case, arrival of the hanging goods at a downstream end of the conveyor needs to be detected, since then no other hanging goods are allowed to be supplied to the conveyor at an upstream end. The present invention particularly relates to an overhead-conveyor system comprising the occupancy rocker.

### RELATED PRIOR ART

Typically, light sensors are used in order to implement this occupancy functionality. The light sensors are arranged in a region where an emitted ray of light is reflected back from the hanging goods to the light sensor and subsequently detected. However, the light sensors have the general disadvantage of not responding to all colors, which is particularly disadvantageous with regard to the fashion industry. Thus, if the hanging goods have a specific color, it might be that no, or only an insufficient, ray of light is reflected so that no occupancy signal is detected, generated and output even though an occupancy state is present. Another disadvantage of the light sensors is to be seen in that operators can walk, or even stand, beneath the perpendicularly orientated light sensors. The overhead conveyor is typically arranged above head height. In this case, a control outputs a wrong notification since it does not detect the hanging goods but the operators.

Of course, there are mechanical solutions as well. One mechanical solution, for example, is to be seen in rockers (seesaws). Mechanical rockers are disadvantageous in that they do not allow the to-be-accumulated hanging goods to pass due to their dead weight in some cases. For example, if the rocker is used with an inclined discharge bar, on which discharge bar the hanging goods slide to a collection point being located deeper, hanging goods of very light weights, which possibly are not sliding well in general, might not lift the rocker in order to pass the rocker. In this case, the (light) hanging goods are stopped at the rocker and do not reach the actual accumulation region located down-stream relative to the rocker.

Another disadvantage of conventional mechanical rockers is to be seen in that each of the rockers needs to be adapted to a specific application and needs to be set correspondingly. Particularly in the fashion industry, there are different hanging sides. In some countries the hanging goods are hung from the left onto the overhead conveyor and, thus, are moved “chest in front” (hanging side at the left). In other countries, the conveyor is hung from the right (hanging side at the right). In dependence on the widths of the hanging goods (as seen in a conveying direction), the geometrical lengths of the rockers need to be adapted to the to-be-accumulated hanging goods. This results, under certain circumstances, in that up to 10 or more different rocker lengths need to be on stockage. This is an enormous disadvantage in the light of standardization and warehouse management. It also represents a source of errors during the planning process of the system. Therefore, one often falls back on electrically actuated light sensors although, in this case, the above mentioned disadvantages are present.

### SUMMARY OF THE INVENTION

Therefore, it is an object of the invention to provide an improved universally applicable occupancy rocker.

This object is generally solved by an occupancy rocker for indicating an occupied state of an accumulation line for hanging conveying goods, wherein the accumulation line is arranged adjacent downstream to the rocker, wherein a plurality of conveying goods is transported downstream actively or passively in a hanging state, wherein each of the conveying goods hangs on a hanger, comprising: an inquiry sword having a long body, wherein a longitudinal extension of the long body comprises a first end and an opposite second end, wherein a continuous opening is provided in the body, the opening preferably being arranged closer to the second end than to the first free end, wherein the sword is arranged within a region which is crossed by the conveying goods when the conveying goods pass the rocker; and a bearing comprising a socket, which is preferably orientated horizontally, the socket reaching through the opening of the sword, wherein the sword, in a normal state when the sword is not in contact with one of the hangers, is supported in a downwardly hanging manner, and wherein the sword is pivotally supported about the socket for being long-term lifted by means of an accumulated conveying good into the occupied state.

According to another aspect of the invention it is disclosed a rocker for indicating an occupancy state of an accumulation line in an overhead-conveyor system configured for transporting hanging conveying goods, wherein the accumulation line is to be arranged downstream adjacent to the rocker, wherein a plurality of the conveying goods is transported downstream actively or passively in a hanging manner, wherein each of the conveying goods hangs on a hanger, the rocker comprising: an inquiry sword having a long body, wherein a longitudinal extension of the long body comprises a first end and an opposite second end, wherein a continuous opening is provided in the body, wherein the sword is to be arranged within a region which is crossed by the conveying goods when the conveying goods pass the rocker; a bearing comprising a socket, the socket reaching through the opening of the sword, wherein the sword, in a normal state when the sword is not in contact with one of the hangers, is supported in a downwardly hanging manner, and wherein the sword is pivotally supported about the socket for being long-term lifted by means of an accumulated conveying good into the occupied state; and a lug which is connected to the second end of the sword and which continues the sword in the longitudinal direction, wherein the lug has a slotted hole extending along the longitudinal direction of the sword.

According to still another aspect of the invention it is disclosed a rocker for indicating an occupancy state of an accumulation line in an overhead-conveyor system configured for transporting hanging conveying goods, wherein the accumulation line is to be arranged downstream adjacent to the rocker, wherein a plurality of the conveying goods is transported downstream actively or passively in a hanging manner, wherein each of the conveying goods hangs on a hanger, the rocker comprising: an inquiry sword having a long body, wherein a longitudinal extension of the long body comprises a first end and an opposite second end, wherein a continuous opening is provided in the body, wherein the sword is to be arranged within a region which is crossed by the conveying goods when the conveying goods pass the rocker; and a bearing comprising a socket, the socket reaching through the opening of the sword, wherein the sword, in a normal state when the sword is not in contact with one of the hangers, is supported in a downwardly hanging manner, and wherein the sword is pivotally supported about the socket for being long-term lifted by means of an accumulated conveying good into the occupied state, wherein the sword comprises a recess being arranged coaxially relative to the socket.

According to still another aspect of the invention it is disclosed a rocker for indicating an occupancy state of an accumulation line in an overhead-conveyor system configured for transporting hanging conveying goods, wherein the accumulation line is to be arranged downstream adjacent to the rocker, wherein a plurality of the conveying goods is transported downstream actively or passively in a hanging manner, wherein each of the conveying goods hangs on a hanger, the rocker comprising: an inquiry sword having a long body, wherein a longitudinal extension of the long body comprises a first end and an opposite second end, wherein a continuous opening is provided in the body, wherein the sword is to be arranged within a region which is crossed by the conveying goods when the conveying goods pass the rocker; and a bearing comprising a socket, the socket reaching through the opening of the sword, wherein the sword, in a normal state when the sword is not in contact with one of the hangers, is supported in a downwardly hanging manner, and wherein the sword is pivotally supported about the socket for being long-term lifted by means of an accumulated conveying good into the occupied state; wherein the sword comprises rib-like slots, which are distributed along the longitudinal direction at distances and which allow adaption of a length of the sword by breaking off an undesired part of the sword

The rocker in accordance with the invention is formed modularly. A sword of the rocker can be arranged both to the left and to the right relative to a discharge bar, but also relative to a conveyor. Thus, it does not matter from which side the conveying goods are hung onto the conveyor. The rocker can be mounted easily and can be adapted on site, for example, with regard to the length of the sword.

In accordance with a preferred embodiment the rocker further includes a lug which is connected to the second end of the sword and which continuous the sword in the longitudinal direction.

The lug has several functions. The lug can be used for attaching a balance weight for reducing the effective weight of the sword which acts on passing hangers. The lug can also be used as a trigger for a (proximity) sensor.

Preferably, the lug has a slotted hole extending along the longitudinal direction of the sword.

The slotted hole allows simple displacement of a balance weight in order to set a condition faster, in which condition the lug and the sword are almost in balance, wherein the weight of the sword predominates.

In particular, the sword, or the lug, has a recess, which has preferably a circular-arc shape, the recess being arranged coaxially relative to the socket. The recess can interact with a stationary pin which in turn limits the maximum deflection of the sword so that the sword always returns safely to its rest point and is always safely deflected, or stays deflected, during passage of one of the hangers.

With another preferred embodiment, the sword, or the lug, is configured to interact with a proximity sensor which detects whether the first free end of the sword is deflected permanently upward due to contact with a resting one of the hangers.

The proximity sensor is arranged such that the operator can cross the rocker of the occupancy-signaling device without triggering the sensor. The sensor is only triggered by the sword or the lug being typically arranged overhead height.

With another embodiment, the rocker further comprises a frame, to which frame the proximity sensor and the bearing are fixed, wherein the frame can be fixed to the accumulation line, and wherein the socket is arranged such that the sword is arranged laterally and horizontally displaced relative to the accumulation line.

The proximity sensor is part of the rocker and can be delivered as a unit so that the sword needs to be mounted on the bearing from the right side on the construction site.

Preferably, a pin is additionally provided which is stationary attached to the frame, in particular with a horizontal orientation, transversely, preferably perpendicular, to the longitudinal direction of the accumulation line, the pin engaging the recess having the circular-arc shape and thus delimiting the maximum deflection of the sword.

With another advantageous embodiment, the sword comprises rib-like slots along the longitudinal side, the slots being distributed in distances and allowing adaption of a length of the sword by breaking off an undesired part of the sword.

In particular, the body of the sword is formed like a plate.

Further, an overhead conveyor having an accumulation line is disclosed, wherein the occupancy rocker of the present invention is provided at an upstream end of the accumulation line.

It is clear that the above mentioned and still to be explained features are not only applicable in the respectively given combination but also in other combinations or alone without departing from the scope of the present invention.

Embodiments of the invention are illustrated in the drawings and will be explained in more detail hereinafter.

### BRIEF DESCRIPTION OF THE DRAWINGS

FIG. 1 shows a side view of a “free” rocker (FIG. 1A) in accordance with the invention, and a side view of an “occupied” rocker (FIG. 1B) in accordance with the invention;

FIG. 2 shows a side view (FIG. 2A) and a front view (FIG. 2B) of a drag conveyor having a rocker in accordance with the invention, if one looks in an upstream direction at the rocker along the conveying direction;

FIG. 3 shows a side view (FIG. 3A) and a front view (FIG. 3B) of a clip conveyor having a rocker in accordance with the invention;

FIG. 4 shows a sword of a rocker in accordance with the invention in a side view (FIG. 4A), an enlarged view in detail (FIG. 4B) within a circle being designated by “B” in FIG. 4A, and a sectional view along a line IV-C-IV-C (FIG. 4C);

FIG. 5 shows a lug of the rocker in accordance with the invention in a side view (FIG. 5A) and a front view (FIG. 5B); and

FIG. 6 shows a bearing of the rocker in accordance with the invention in a side view (FIG. 6A) and a front view (FIG. 6B).

### DESCRIPTION OF PREFERRED EMBODIMENTS

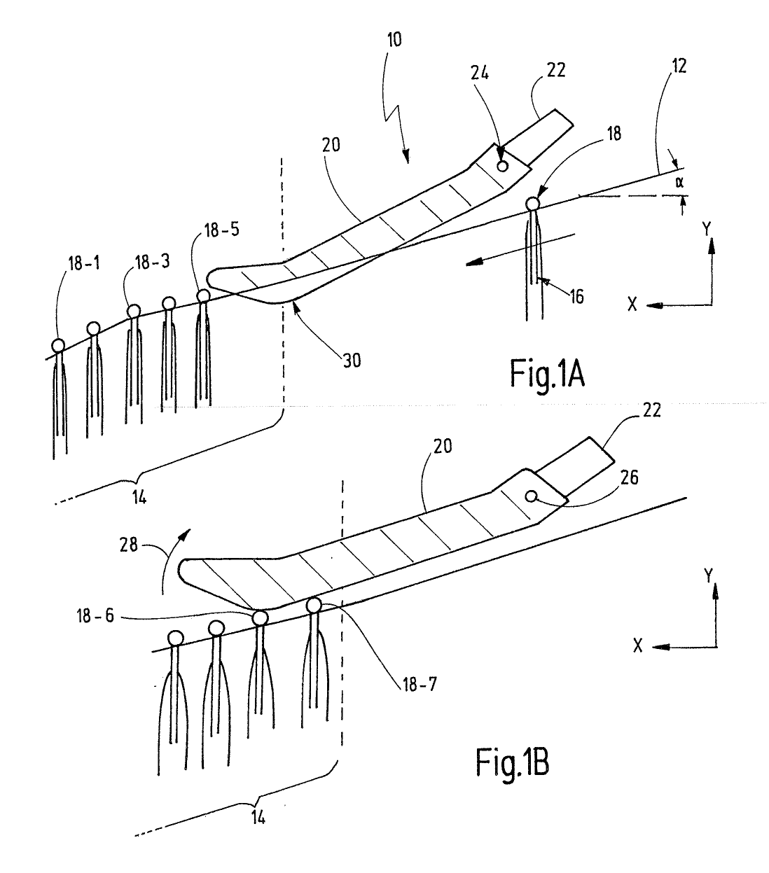

FIG. 1A shows a side view of a “free” rocker 10 in accordance with the present invention. Here, the rocker 10 is used at a discharge bar 12 which in turn can be part of an overhead-conveyor system. Discharging bars 12 are used in particular for sorting purposes by arranging the discharge bars 12 laterally relative to a main conveying line, wherein conveying goods 16 are discharged from the main line into or onto the corresponding discharge bars 12. The discharge bars 12 are typically inclined slightly. This is indicated in FIG. 1A by means of an angle α. Conveying goods 16, which have been sorted out, are sliding independently, i.e. only due to gravity, downwards on the bar 12 as indicated by an arrow orientated to the left. The discharge bars 12 can be used for collecting different conveying goods 16 which have been discharged onto a corresponding one of the discharge bars 12, for example, in accordance with a picking order. The conveying goods 16 (e.g., garments) are typically hanging on hangers 18. The more conveying goods 16 are discharged to the discharge bar 12, the more conveying goods 16 are collected and accumulated. Since each discharge bar 12 has a limited capacity, the discharge bar 12 steadily fills up to a certain point when no additional conveying goods 16 can be received any more without risking collision of the accumulated conveying goods 16 with such conveying goods 16 being transported on the main conveying line. An accumulation line (region on the discharge bar 12) is indicated in FIG. 1A by means of reference numeral 14, an upstream end of the accumulation line being indicated by means of a vertically-orientated line of dots. In FIG. 1A already five conveying goods 16 are collected in the accumulation line 14. There is only little space for receiving additional conveying goods 16 until the upstream end of the accumulation line 14 is reached.

The rocker 10 in accordance with the invention is used for allowing detection of the filling state of the accumulation line 14. The rocker 10 comprises an (inquiry) sword 20. The rocker 10 can comprise a lug 22 preferably extending oppositely relative to the sword 20. The sword 20 can be supported pivotally about a pivotal axis 24 which is realized by a (bushing-type) bearing 26 (cf. also FIG. 1B). The sword 20 (and the lug 22) are rotated clockwise around the pivotal axis 24 in FIGS. 1A and 1B, as soon as the remaining residual space of the accumulation line 14 is occupied by additional conveying goods 16, as indicated in FIG. 1B. The side view of FIG. 1B shows the discharge bar 12 including the rocker 10 of FIG. 1A at a later time. Two additional conveying goods 16 have filled the accumulation line 14 at this time. These two new conveying goods 16 are responsible for lifting the sword 20 and let the sword 20 perform a pivotal movement 28, as indicated in FIG. 1B by means of an arrow. Deepest point 30 of a contour of the sword 20 (cf. FIG. 1A) is lifted above the level of the discharge bar 12. In this context, the sword 20 rotates in a clockwise direction. The same applies with regard to the lug 22 which can be located, relative to the pivotal axis 24, oppositely to the sword 20. The lug 22 be used for activating a sensor, which is not shown in further detail in FIGS. 1A and 1B, the sensor in turn detecting the filled condition of the accumulation line 14 and outputting a corresponding signal to a superordinated (not shown) material flow computer.

It is clear that the length of the accumulation line 14 can influence the length of the sword 20. It is further clear that the length of the sword 20 is dependent on the width of the conveying goods 16 in the direction X. If the conveying goods 16 (in the direction X) are very broad, a relative distance between neighboring hangers 18 is correspondingly big. Thus, it can be imaged that, at a very big distance, neighboring hangers 18 do not deflect the rocker 10, or the sword 20 thereof, because the sword 20 engages the space between the neighboring hangers 18 without being lifted although the accumulation line 14 is already filled up. This means that the length of the sword 20 becomes bigger and bigger, the broader the to-be-accumulated conveying goods 16 are. However, the length of the sword 20 can be set with the present invention in a simple manner by cutting the sword 20 on the construction site correspondingly, as will be explained in more detail below. For this purpose, the sword 20 comprises, for example, regularly distanced slots 78 being orientated transversely relative to the longitudinal direction of the sword 20.

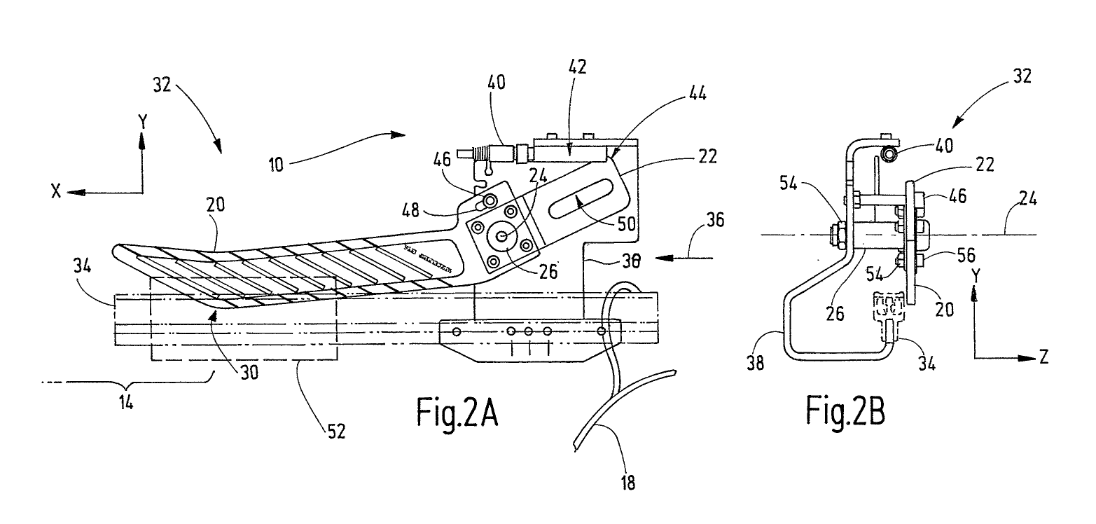

The FIGS. 2A and 2B show the rocker 10 with a drag conveyor 32 trans-porting the hangers 18 on a transportation rail 34 along a transporting direction 36. FIG. 2A shows a side view and FIG. 2B shows a front view, if one looks upstream at the rocker 10 in the conveying direction 36. The subsequent part of the description relates to the FIGS. 2A and 2B in common.

The rocker 10 comprises a frame 38 which in the present case, for example, comprises a C-shaped cross section (cf. FIG. 2B), for positioning, in particular, the components 20, 22 and 26 of the rocker 10 laterally relative to the transportation rail 34. The frame 38 can also be used for supporting the transportation rail 34.

The rocker 10 further comprises a sensor 40 in terms of a proximity switch, or proximity sensor, 42 which is also arranged at the frame 38. The proximity sensor 42 uses one or more sensors which respond, preferably in a non-contacting manner, to an approach, i.e. without direct contact in particular. Proximity switches are used in the field of overhead conveyors for detecting positions (in the present case, for example, of the lug 22) and also as triggers of safety measures. There are different types of proximity switches. Inductive proximity switches exist which respond to the occurrence of an eddy current in the context of both ferromagnetic and also non-magnetic, but metallic, objects. Capacitive proximity switches exist which also respond to non-conductive materials. Magnetic proximity switches exist (e.g., Reed switches or Reed contacts) responding to a magnetic field. Optical proximity switches exist responding to light reflections. Further, light barriers exist. Supersonic proximity switches receive reflections of a supersonic signal. With electromagnetic proximity switches a resonant frequency of an oscillating circuit changes under approximation so that it can respond to both conductive and also non-conductive materials.

In the present example of FIG. 2 the proximity sensor 42 responds, for example, inductively to an upper corner 44 of the lug 22. It is clear that the lug 22 is not necessarily required. If the lug 22 is not part of the rocker 10, the proximity sensor 42 could be arranged in a region so that the proximity sensor 42 interacts with the sword 20. It is clear that also sensors which respond to contact can be used.

The rocker 10 of FIG. 2 further comprises a pin 46. The pin 46 is orientated horizontally and is fixed to the frame 38. The pin 46 engages a recess 48 in the sword 20. The recess 48, which preferably has a circular-arc shape and which is arranged coaxially relative to the pivotal axis 24, limits the deflections of the sword 20 possible at maximum. In FIG. 2A the rocker 10, or the sword 20 thereof, is shown in a “free” position (cf. FIG. 1A), in which free position the sword 20 hangs beneath a conveying level of the hangers 18 (top side of the transportation rail 34 in the present case). The pin 46 abuts against the right edge of the recess 48 which is penetrated by the pin 46. In this manner, the sword 20 is prevented from hanging perpendicularly downward. The right edge of the recess 48 therefore defines a normal position. The left edge of the recess 48 delimits the deflection of the sword 20, which is possible at maximum, if one of the hangers 18 passes the sword 20 and thus lifts the sword 20. In practice, it can happen that the hangers 18 are conveyed at very high velocities so that high carry-over of energy to the sword 20 can happen during passage of the hanger 18. In order to avoid that the sword 20 rests in the upper region of the rocker 10 (e.g., stands perpendicularly upward) and does not return to its measuring position, or rest point, the left edge of the recess 48 delimits this error state.

The lug 22 can comprise a slotted hole 50 which is suitable for receiving a tare weight (not illustrated). The slotted hole 50 extends, preferably in the longitudinal direction of the sword 20. The balance weight (not shown) in the slotted hole 50 can be arranged such that only a fraction of the weight of the sword 20 acts on the hanger 18, in order to reduce the weight of the sword 20 which effectively acts on the hanger 18. In this case, at the side of the lug 22, so many weights are attached until almost an equilibrium is generated, similarly as with a conventional pendulum scale, wherein the side of the sword 20—relative to the pivotal axis 24—is still heavier.

The sword 20 is arranged with its deepest point 30 of the contour of the sword 20 in a passage region 52 which is always crossed by the passing hangers 18 and which causes lifting of the sword 20 if one of the hangers 18 passes the sword 20.

Both the pin 46 and the bearing 26, at which bearing 26 the sword 20 and the lug 22 rest freely rotatable, can be threaded for being connected stationary to the frame 38 by means of nuts 46. The sword 20 and the lug 22 can be connected rigidly to each other by means of nut-screw-connections 54, 56. Alternatively, the sword 20 and the lug 22 can be formed integrally.

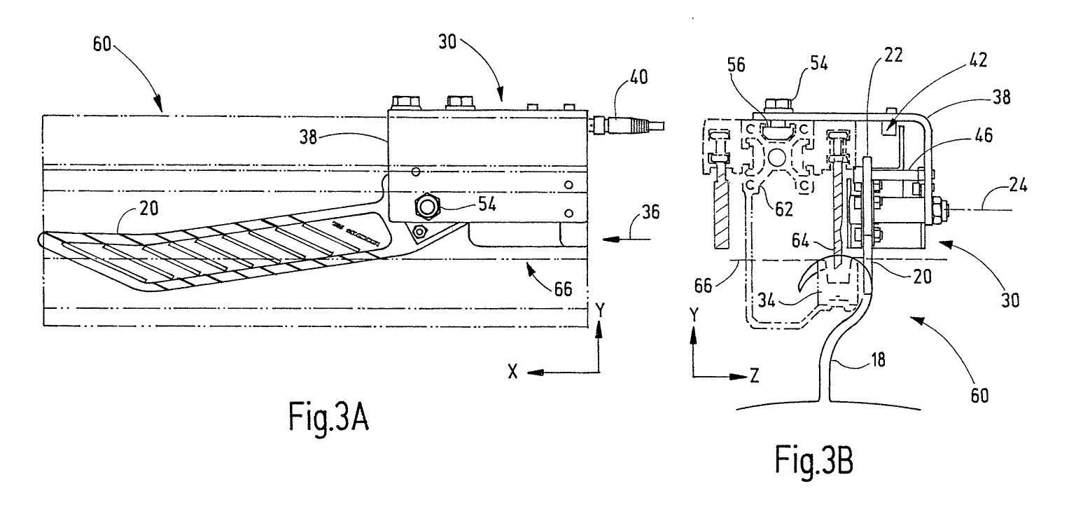

The use of the rocker 10 in the context of a clip conveyor 60 will be explained below with common reference to the FIGS. 3A and 3B. The clip conveyor 60 comprises a supporting section 62, by which supporting section a (not shown) conveying chain is guided. The clip conveyor comprises a plurality of clip drivers 64 transporting hangers 18 (FIG. 3B) in a laying manner on a transportation rail 34. The sword 20 of the rocker 10 is arranged laterally relative to the transportation rail 34 such that a passing hanger 18 definitely deflects the sword 20. The sword 20 is arranged at a level of the conveying level 66 of the hangers 18.

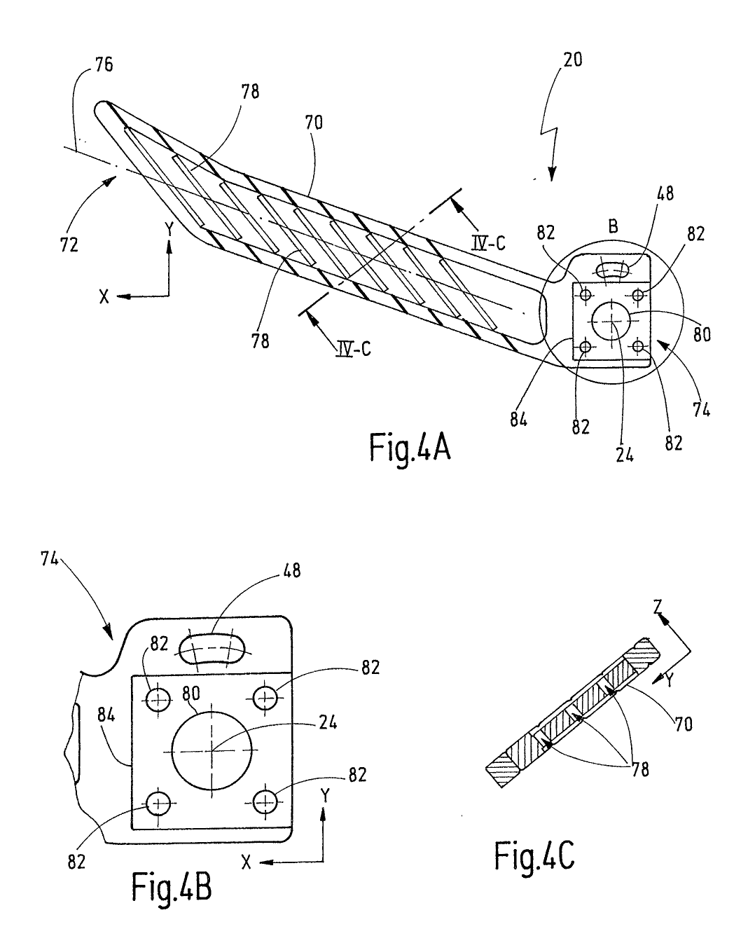

With common reference to the FIGS. 4A to 4C a sword 20 of the rocker 10 is explained isolatedly below. FIG. 4A shows a side view. FIG. 4B shows a region in an enlarged illustration of FIG. 4A being enclosed by a circle “B”. FIG. 4C shows a sectional view along a line IV-C/IV-C through a body 70 of the sword 20.

The body 70 of the sword 20 comprises a first end 72 and a second end 74 being arranged oppositely in a direction of a longitudinal extension 76 of the body 70. The first end 72 is the free end of the sword 20 and serves for inquiring the hangers 18. The second end 74 serves for receiving the bearing 26. A substantial part of the body 70 is formed like a plate having slots 78 (cf. sectional view of FIG. 4C) which extend trans-versely relative to the longitudinal direction 76, preferably at regular distances, and being formed continuously, wherein this substantial part of the of the body 70 extends from the free end 72 towards the second end 74. The shape, the position and the orientation of the slots 78 can be chosen arbitrarily. The slots 78 allow simple and fast adaption of the length of the sword 20 during installation of the rocker 10 on the construction site. Lengths of the body 70, which are not required, can be broken off or cut away easily, for example, in the region of the slots 78.

In the region of the second end 74 the plate-like body 70 transists to a connecting and bearing region, which is not designated in more detail, being illustrating enlarged in FIG. 4B. This region comprises an opening 80 formed and adapted to receive the bearing 26. Further, exemplarily four additional openings 82 are provided, serving for connecting the sword 20 to the lug 22. A region 84 indicated by means of a square represents a contact area of the sword 20 to the lug 22.

The recess 48 is arranged coaxially relative to the pivotal axis 24. It is clear that the recess 48 does not necessarily need to be formed like a circle. Merely the edges of the recess 48 in a circumferential direction are significant because these edges, together with the pin 46, delimit the maximum deflection of the sword 20.

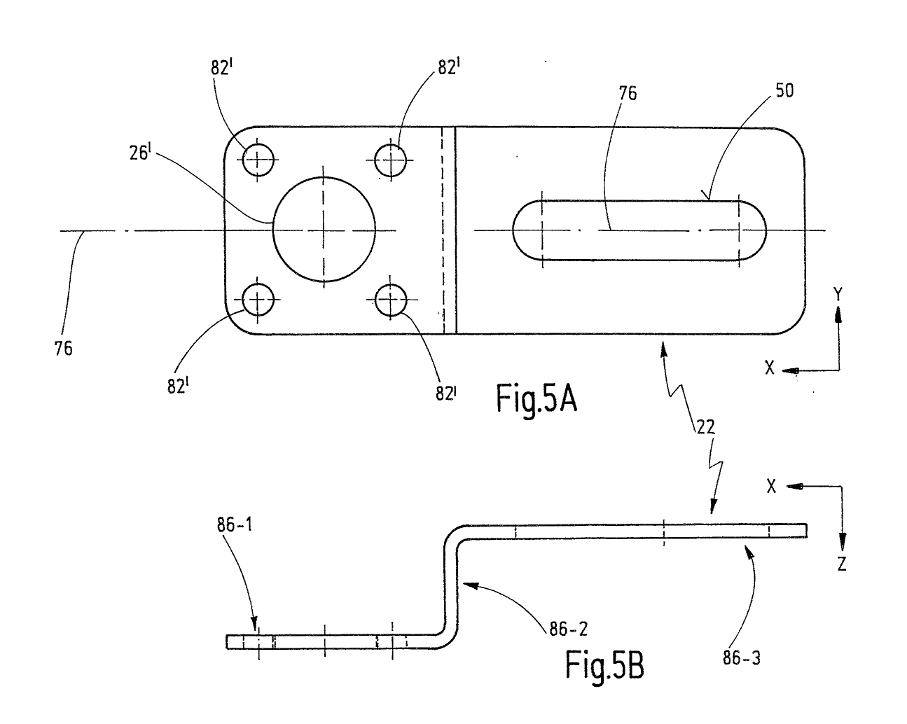

With common reference to the FIGS. 5A and 5B hereinafter a possible embodiment of a lug 22 is described. FIG. 5A shows a side view of the lug 22. FIG. 5B shows a top view of the lug 22.

In the top view of FIG. 5B, a Z-shaped embodiment of the lug 22 can be recognized well. The lug 22 comprises a first leg 86-1 and a third leg 86-3, which are orientated in the longitudinal direction X and which are connected to each other by means of a second leg 86 which in turn is orientated in the transverse direction Z. It is clear that the lug 22 can also be provided without the second leg so that the lug 22, in this case, would only extend in the longitudinal direction X. Other orientations are also possible.

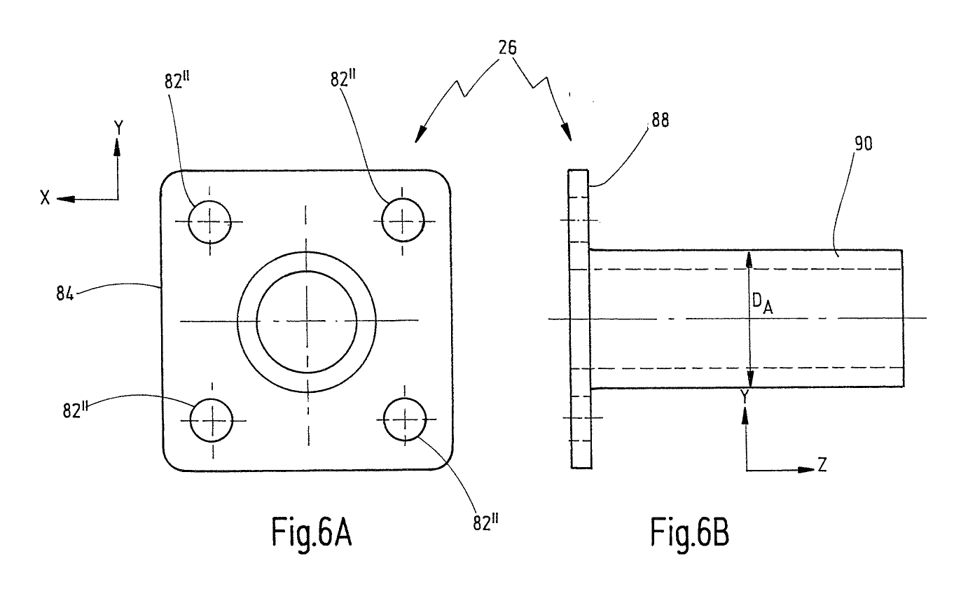

FIG. 6A shows a side view of the bearing 26. FIG. 6B shows a front view of the bearing 26 if one looks upstream (or downstream) at the bearing 26 in the conveying direction 36.

The bearing 26 comprises a base plate 88 and a socket 90, which is preferably orientated perpendicular thereto. The base plate 88 can have additional openings 82″ which are arranged such that they map the openings 82 and 82′ of the sword and the lug 22, in order to connect the sword 20, the lug 22 and the base plate 88 rigidly to each other by means of nut-screw connections 54-56. In this case, the right end of the socket 90 (cf. FIG. 6B) is supported freely rotatable in the frame 38.

FIGS. 4 to 6 show that the sword 20 can be used universally at both sides of a conveying line. The applications of the FIGS. 2 and 3 show the sword on the right hand side (cf. FIGS. 2B and 3B). However, it is clear that by simply replugging the bearing 26 relative to the sword, also a left-orientated arrangement of the sword 20 relative to the conveying line is possible. This orientation can also be executed only during the installation process on the construction site. In this sense, there are no “left” and “right” rockers 10. The rocker 10 in accordance with the present invention has a modular design and can be used universally. The sword 20, in this sense, is formed symmetrically so that the bearing 26 can be inserted from both sides. The problem of the mounting side, as mentioned at the outset, is not present. At the same time, it is possible to use the rocker 10 with both discharging bars 10 and driven conveyors 32 and 60.

A base module of the sword 20 has a maximum length for providing different required lengths of the sword 20. This length is perforated, preferably in regular distances, by means of the slots 78 so that on the construction site a suitable rocker 10 can simply be formed of a rocker 10 which might be too long. The problem of a too high dead weight of the sword 20 (undesired accumulation of light conveying goods 16) can be solved by means of the lug 22 by attaching additional balance weights thereto.

With the above given description of the invention, identical parts and features have been designated by the same reference numerals, wherein the disclosures contained in the entire description can be roughly transferred to parts and features having identical reference numerals. Attitudes such as “above”, “below”, “lateral”, “vertical”, “horizontal” etc. refer to the immediately described figures and are to be roughly transferred to new attitudes, if position changes.

Further, it is to be noted that indications of directions and orientations have been used which refer to designations typically used in (intra) logistics. Hence, the length direction (conveying direction) is designated by “X”, the depth (width) is designated by “Z” and the (logical) height is designated by “Y”. The figures respectively show a corresponding (Cartesian) coordinate system X, Y, Z.

Therefore, what is claimed is:

1. A rocker for indicating an occupancy state of an accumulation line in an overhead-conveyor system configured for transporting hanging conveying goods, wherein the accumulation line is to be arranged downstream adjacent to the rocker, wherein a plurality of the conveying goods is transported downstream actively or passively in a hanging manner, wherein each of the conveying goods hangs on a hanger, the rocker comprising:
an inquiry sword having a long body, wherein a longitudinal extension of the long body comprises a first end and an opposite second end, wherein a continuous opening is provided in the body, wherein the sword is to be arranged within a region which is crossed by the conveying goods when the conveying goods pass the rocker;
a bearing comprising a socket, the socket reaching through the opening of the sword, wherein the sword, in a normal state when the sword is not in contact with one of the hangers, is supported in a downwardly hanging manner, and wherein the sword is pivotally supported about the socket for being long-term lifted by means of an accumulated conveying good into the occupied state; and
a lug which is connected to the second end of the sword and which continues the sword in the longitudinal direction,
wherein the lug has a slotted hole extending along the longitudinal direction of the sword.

2. A rocker for indicating an occupancy state of an accumulation line in an overhead-conveyor system configured for transporting hanging conveying goods, wherein the accumulation line is to be arranged downstream adjacent to the rocker, wherein a plurality of the conveying goods is transported downstream actively or passively in a hanging manner, wherein each of the conveying goods hangs on a hanger, the rocker comprising:
an inquiry sword having a long body, wherein a longitudinal extension of the long body comprises a first end and an opposite second end, wherein a continuous opening is provided in the body, wherein the sword is to be arranged within a region which is crossed by the conveying goods when the conveying goods pass the rocker; and
a bearing comprising a socket, the socket reaching through the opening of the sword, wherein the sword, in a normal state when the sword is not in contact with one of the hangers, is supported in a downwardly hanging manner, and wherein the sword is pivotally supported about the socket for being long-term lifted by means of an accumulated conveying good into the occupied state, wherein the sword comprises a recess being arranged coaxially relative to the socket.

3. The rocker of claim 2, wherein the recess has a shape of a circular-arc.

4. The rocker of claim 2, wherein the sword is formed to interact with a proximity sensor which detects whether the first free end of sword is long-term lifted upwardly due to a contact of the sword with a standstill conveying good beneath.

5. The rocker of claim 4, further comprising a frame which is mounted to the proximity sensor and the bearing, wherein the frame is mounted to the accumulation line, and wherein the socket is arranged such that the sword is arranged laterally and horizontally displaced relative to the accumulation line.

6. The rocker of claim 2, further comprising a pin, which is stationary fixed to the frame transversely relative to the longitudinal direction of the accumulation line, wherein the pin engages the recessand limits maximum deflections of the sword.

7. The rocker of claim 6, wherein the pin is arranged in a horizontal orientation.

8. A rocker for indicating an occupancy state of an accumulation line in an overhead-conveyor system configured for transporting hanging conveying goods, wherein the accumulation line is to be arranged downstream adjacent to the rocker, wherein a plurality of the conveying goods is transported downstream actively or passively in a hanging manner, wherein each of the conveying goods hangs on a hanger, the rocker comprising:
an inquiry sword having a long body, wherein a longitudinal extension of the long body comprises a first end and an opposite second end, wherein a continuous opening is provided in the body, wherein the sword is to be arranged within a region which is crossed by the conveying goods when the conveying goods pass the rocker; and
a bearing comprising a socket, the socket reaching through the opening of the sword, wherein the sword, in a normal state when the sword is not in contact with one of the hangers, is supported in a downwardly hanging manner, and wherein the sword is pivotally supported about the socket for being long-term lifted by means of an accumulated conveying good into the occupied state;
wherein the sword comprises rib-like slots, which are distributed along the longitudinal direction at distances and which allow adaption of a length of the sword by breaking off an undesired part of the sword.

9. The rocker of claim 8, wherein the body of the sword has a plate-like shape.
